(19) United States
(12) Patent Application Publication
(10) Pub. No.: US 2008/0221850 A1
(43) Pub. Date: Sep. 11, 2008

(54) Effective current density and continuum models for conducting networks

(75) Inventor: Donald Bennett, Lochore (GB)

Correspondence Address: Rajendran Nair;ComLSl Inc., 3838 E Encinas Ave, Gilbert, AZ, 85234, US

(73) Assignee: Anasim Corporation

(21) Appl. No.: 11/714,427

(22) Filed: Mar. 7, 2007

(51) Int. Cl. G06F 17/50

(52) U.S. Cl. 703/14; 703/18

(57) ABSTRACT

An Effective Current Density (ECD) method for continuum representation of conducting networks is disclosed. ECD is a method for representing large numbers of conductors in a single, compact model for use in circuit simulation and in other such applications. The models created through the application of ECD are continuum models, valid in both long and short wavelength limits, with the important property that the computation time does not grow with the number of wires in the network. Therefore, in circuits where the method can be applied, there is no limit to the number of conducting wires or components in the network to be simulated. Circuits with an unlimited number of conductors can be simulated using modest computing hardware and at an approximately constant order of simulation complexity.

### RELATED DOCUMENTS

None are known to exist at this time.

### TECHNICAL FIELD OF THE INVENTION

The invention relates to methods for current density representation and simulation complexity reduction within conducting systems. Embodiments and applications of the invention fall under the general category of Circuit Modelling and Simulation.

### BACKGROUND AND PRIOR ART

Circuit simulation programs such as SPICE and SPICE derivatives have been used extensively for several decades as aids to electronic circuit design. These simulation programs rely on a comprehensive set of models to represent the various components that make up an electrical circuit. These models range from simple representations of passive components (ideal resistors, capacitors etc.) to complex mathematical representations of semiconductor devices.

Simulation models have evolved in different ways in an attempt to keep pace with growing complexity and component numbers in modern circuit designs. For example, semiconductor device models can be optimized for accuracy or speed depending on the specific application or the needs of the circuit designer. Even very simple optimizations can have a dramatic effect on the computation time required to simulate systems containing large numbers of devices.

A common example of circuit optimization is the combination of two or more (ideal) resistors wired in parallel. All of these components can be represented by a single resistor. This can result in a dramatic reduction in the number of components to be simulated in a large network. However, this type of component reduction is limited to applications where only the resistance of wires in the network is needed for an accurate simulation. In cases where the inductance and capacitance of a wire has a significant effect on voltage and current in a network a more complex reduction method is required. Component reduction can be impossible when wavelengths are comparable to or shorter than the device length. In these cases conductors are represented by transmission lines with no simple relation between voltage and currents at the various terminals within the network.

### INVENTION SUMMARY

The invention effective current density (ECD) model is a method for representing large numbers of conductors in a single, compact model for use in circuit simulation and such other applications. ECD provides continuum models, valid in the long and short wavelength limits, with the important property that the computation time does not grow with the number of wires in the network. Therefore, in circuits where the ECD method can be applied, there is no limit to the number of conducting wires or components in the network to be simulated. Circuits with large numbers of conductors can be simulated in approximately constant time using modest computing hardware.

### BRIEF DESCRIPTION OF FIGURES

FIG. 1 shows a cross-sectional area comprised of conductors and insulators

FIG. 2 shows a conductor cross-sectional area as well as an arbitrary area

FIG. 3 shows multiple conductors included within a cross-sectional area

FIG. 4 illustrates a portion of a network of interconnecting conductors

FIG. 5 shows a 2-dimensional conducting grid

FIG. 6 illustrates a 2-dimensional conducting grid divided into area elements

FIG. 7 illustrates symmetry in a 2-dimensional interlaced conducting grid

FIG. 8 illustrates a symmetric wiring network of a given size

FIG. 9 shows a simulation result at a specific time point t1˜=40 ps

FIG. 10 shows the noise result at another, later time point t2˜=200 ps

FIG. 11 shows a changed simulation result at t1 with a change in wire spacing

FIG. 12 shows a changed result with different wire spacing at another, later time point t2

### DETAILED DESCRIPTION AND SPECIFICATION

2. Definition of the Effective current Density.

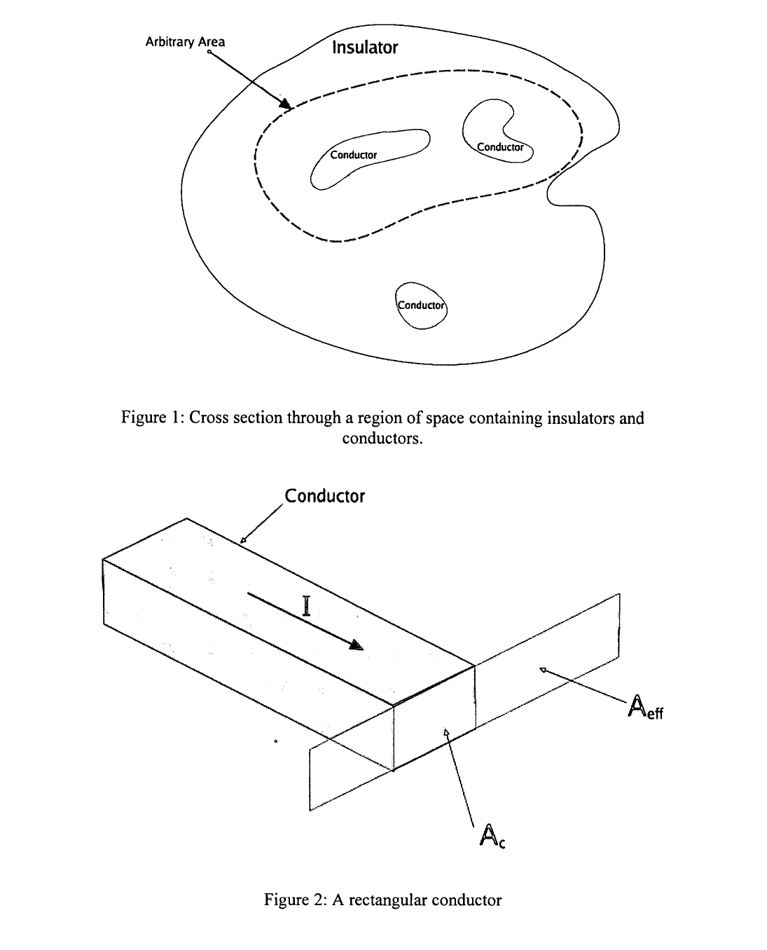

FIG. 1 shows a cross section through a region of space containing insulators and conductors.

Average current density for a conductor is defined by the total current flowing in the conductor normal to the cross sectional area divided by the area of the conductor cross section (prior art).

Effective current density for a conductor is defined by the total current flowing in the conductor normal to the cross sectional area divided by an arbitrary area. The boundary of the conductor cross-section does not coincide with the boundary of the chosen arbitrary area.

The current in the conductor is given by:

I=A_{c}Jₐᵥ=A_{eff}J_{eff} (2.1)

where Jₐᵥ is the average current density, J_{eff} is the effective current density, A_{c} is the area of the conductor and A_{eff} is an arbitrary area. Thus, the two current densities are related by:

$${J}_{av} = \frac{{A}_{eff}}{{A}_{c}} {J}_{eff} \qquad ( 2.2 )$$

For example, FIG. 2 shows a rectangular conductor with cross sectional area A_{c}. Also shown is an arbitrary area A_{eff}. If this conductor is used to transfer charge from one place to another the amount of charge can be calculated using average current density or effective current density. The results are identical as long as the appropriate area is used in the calculation.

This flexibility in describing the flow of charge around a network can be used to develop compact continuum models for the circuit wiring and other components. Average current density is commonly used in many applications as a way of avoiding the complexity associated with variations of current density across a conductor due to surface roughness, material defects, skin effect etc. Effective current density differs from the prior art by extending this simplification to include cross-sectional area other than the conductor cross section.

Since there is little or no current flow in the insulators that lie between or embed conductors in a network, it is not obvious that there are any advantages in extending the definition of current density to include these regions. The utility of the effective current density method only becomes apparent when it is used to derive continuum models for systems containing large numbers of conductors, semiconductors and other components.

### 3. Effective Current Density and Virtual Currents.

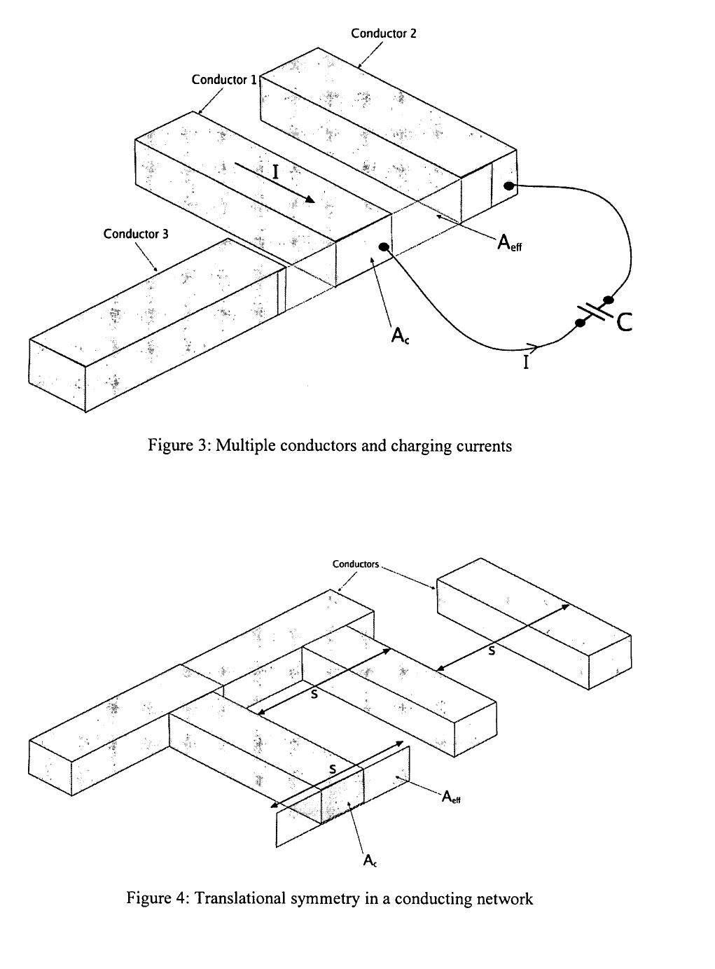

The area used to calculate effective current density for a particular conductor can overlap other conductors in the network. For example, the area A_{eff} shown in FIG. 3 is used to define the effective current density for conductor 1. A_{eff} also occupies some of the space containing conductors 2 and 3. This has no effect on the calculation of the various charging currents in a network. Effective current can be considered to flow in a virtual space that coincides with the real space containing the conductors. The charge flow in the capacitor C can be calculated using the real current in the wire, the average current density or the effective current density. The different current densities are always related to the real current by equation 2.1.

### 4. Symmetry in Networks Containing Conductors, Insulators and Other Components.

Various symmetries in the physical layout of a conducting network, such as invariance during spatial translations or rotations, can often be used to simplify the partial differential equations that result when using the effective current density method to derive the corresponding continuum model. For example, FIG. 4 shows part of a conducting network. Some of the conductors in the network are equally spaced with periodic distance s.

The effective current density methodology always includes the selection of an appropriate, arbitrary area as defined in equation 2.1. Selecting dimensions for the arbitrary area which match the geometry and symmetries in the physical layout of the network can result in a simpler set of partial differential equations in the final continuum model. Thus the identification of symmetries in a circuit layout will often play an important role in model construction.

### 5. Example of a Continuum Model Constructed Using the Effective Current Density Method.

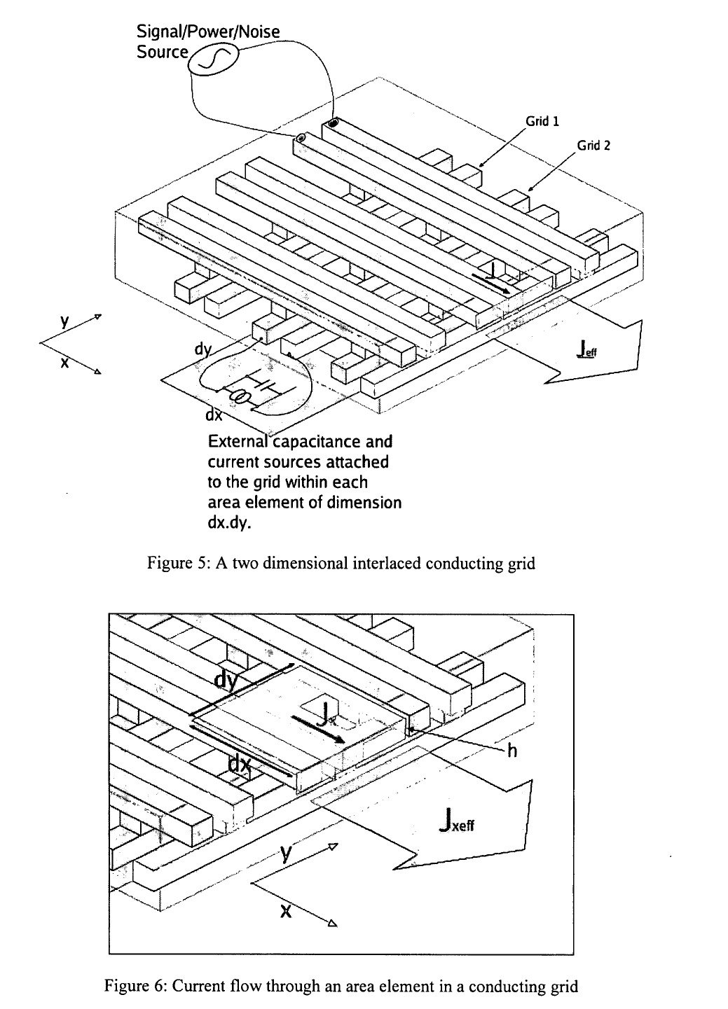

The two dimensional conducting grid illustrated in FIG. 5 consists of two interlaced networks called grid 1 and grid 2. This type of grid can be used to carry power and/or current and voltage signals across an integrated circuit or printed circuit board. The grid may also propagate unwanted signals or noise. Typically this type of grid will be much larger and will contain many more wiring elements than shown here. The grid is two dimensional in the sense that the short vertical conductors that connect the horizontal conductors at crossover points are assumed to have negligible impedance. This particular network is constructed using wires routed in orthogonal directions. Voltage and current flow in this type of grid is conveniently represented in a Cartesian coordinate system. Other types of grids with different geometry may be represented using a different set of basis vectors.

The type of network shown in FIG. 5 can be simulated using methods such as SPICE and SPICE derivatives as described in the prior art. In these methods the grid is deconstructed to form a connected network of short wiring elements. Each wire element is represented by a combination of resistance, capacitance and inductance models (RLC models) or, alternatively, by a transmission line model. These methods have the disadvantage that the simulation time grows with the wire density in the grid.

A network with a large number of wire elements per unit area can often result in excessive numbers of RLC or transmission line components in the final netlist. The requirements for a full, dynamic, RLC simulation for a large network can often exceed the capability of available computing hardware.

A large netlist or part of a netlist can be replaced by continuum models derived using the effective current density method. The run time for the equivalent of a full RLC simulation using a continuum model remains constant as the number of wire elements per unit area grows. This means that the method can be used to reduce overall simulation times, particularly in systems containing large, dense wiring networks.

We begin the analysis by dividing the conducting grid into area elements as shown in FIG. 6.

Current flows in both directions into and out of each area element. The rectangular area element shown has length dx in the x direction and length dy in the y direction. As explained in section 3, this current can be represented by the average current density or the effective current density for each area element and for each interlaced grid. In this analysis a rectangular area is selected to calculate the effective current density. The length of this rectangle has length equal to the length of a side of the area element and width equal to the thickness of wires in the grid. Thus current into the area element in the x direction on grid 1 is given by:

Iₓᵢ=J_{xeff}(x,y)hdy (5.1)

where J_{xeff}(x,y) is the component of effective current density in the x direction at location (x,y) and h is the grid conducting wire thickness. Current out of the area element in the x direction on grid 1 is given by:

Iₓₒ=J_{xeff}(x+dx,y)hdy (5.2)

where J_{xeff}(x+dx,y) is the component of effective current density in the x direction at location (x+dx,y). Similar expressions can be written for current in the y direction. Current into the area element in the y direction on grid 1 is given by:

I_{yi}=J_{yeff}(x,y)hdx (5.3)

where J_{yeff}(x,y) is the component of effective current density in the y direction at location (x,y) Current out of the area element in the y direction on grid 1 is given by:

I_{yo}=J_{yeff}(x,y+dy)hdx (5.4)

where J_{yeff}(xy+dy) is the component of effective current density in the y direction at location (xy+dy).

A conducting network such as the grid illustrated in FIG. 5 will often contain other components. The grid may carry signals, noise and/or power to and from these components. The physical characteristics of these devices can be included in the continuum model by dividing the appropriate physical quantity by some area. In this case the area of the area element. For example, FIG. 5 shows local capacitors and current sources connected to the grid. If these devices are connected to the grid using conductors with lengths significantly less than the shortest wavelength in the system they can be represented as ideal capacitance and current sources. These are included in the continuum model in the form of capacitance per unit area and current per unit area.

The continuum model may also be included in larger system level simulations containing additional wiring, other continuum models and other types of simulation model. Each continuum model can be connected to system nodes using appropriate per-unit-area connections at specific locations within the boundary of the network. Since these connections can be placed anywhere they are represented by functions of position within the boundary of the continuum model. Thus, after an infinitesimal time dt the accumulated charge within the area element could be given by:

dQ=(Iₓᵢ−Iₓₒ+I_{yi}−I_{yo}−I_{A}dxdy−I_{E}dxdy)dt (5.5)

where I_{A} is the current per unit area flowing directly through local devices from grid 1 to grid 2 within the element and I_{E} is the current per unit area flowing indirectly through external (system level) devices from grid 1 to grid 2 within the element. This separation of current sources into direct and indirect types is convenient when incorporating the effective current density model into a larger system level model. The two sources can be combined into a single (parallel) source if required. Alternatively, the total current density at each location on the grid can be split into any number of parallel sources as required.

The accumulated charge within the area element can also be written as:

dQ=C_{A}(dV₁−dV₂)dxdy (5.6)

where C_{A} is the capacitance per unit area within the area element, dV₁ is the change in grid 1 potential within the element during time dt and dV₂ is the change in potential in grid 2 within the element during time dt. The capacitance per unit area C_{A} includes the grid self capacitance and any additional capacitance connected between grids 1 and 2 within the area element. For example, the capacitance of electronic components or other wiring connected to the grid. Equations 5.1 to 5.6 can be combined into the following expression which relates the divergence of the effective current density to the various current components flowing into and out of each infinitesimal area element at all points across the surface of the grid:

$$- h ( \frac{\partial {J}_{xeff}}{\partial x} + \frac{\partial {J}_{yeff}}{\partial y} ) = {I}_{A} + {I}_{E} + {C}_{A} \frac{\partial ( {V}_{1} - {V}_{2} )}{\partial t} \qquad ( 5.7 )$$

where V₁ and V₂ are the potentials of grids 1 and 2 at location (x,y). Equation 5.7 can be written using compact vector notation:

$$- h ∇ \cdot \underline{{J}_{eff}} = {I}_{A} + {I}_{E} + {C}_{A} \frac{\partial ( {V}_{1} - {V}_{2} )}{\partial t} \qquad ( 5.8 )$$

where:

J_{eff}=J_{xeff}i+J_{yeff}j (5.9)

is the effective current density at position (x,y) and i and j are unit vectors in the x and y directions. These currents are associated with resistive and inductive voltage changes in the grid. For example, the voltage change in the x direction in grid 1 across the area element can be written as:

$$- {dV}_{1 x} = {J}_{1 x} {h}_{1 x} {w}_{1 x} ( {R}_{1 s} \frac{dx}{{w}_{1 x}} ) + {\sum }_{j = 1}^{k} [ {L}_{1 j} dx \frac{\partial }{\partial t} ( {J}_{jx} {w}_{jx} {h}_{jx} ) ] \qquad ( 5.10 )$$

where:
J₁ₓ is the component of average current density in the x direction due to wires in grid 1.
h₁ₓ is the height of wires in grid 1 that pass through the area element routed in the x direction.
w₁ₓ is the width of wires in grid 1 that pass through the area element routed in the x direction.
R₁ₛ is the sheet resistance of wires in grid 1 routed in the x direction that pass through the area element.
L₁ⱼ is the mutual inductance per unit length between a wire in grid 1 routed in the x direction and the j^{th} wire in the grid (for example, a wire with significant magnetic coupling to wires in grid 1 that pass through the area element).
Jⱼₓ is the component of average current density in the x direction in the j^{th} neighbouring wire.
wⱼₓ is the width of the j^{th} neighbouring wire (routed in the x direction of an orthogonal grid described in a Cartesian coordinate system).
hⱼₓ is the height of the j^{th} neighbouring wire (routed in the x direction of an orthogonal grid described in a Cartesian coordinate system).
k is the number of wires in the grid.

Similarly, the voltage change in the y direction in grid 1 across the area element is given by:

$$- {dV}_{1 y} = {J}_{1 y} {h}_{1 y} {w}_{1 y} ( {R}_{1 s} \frac{dy}{{w}_{1 y}} ) + {\sum }_{j = 1}^{k} [ {L}_{1 j} dy \frac{\partial }{\partial t} ( {J}_{jy} {w}_{jy} {h}_{jy} ) ] \qquad ( 5.11 )$$

where:
J_{1y} is the component of average current density in the y direction due to wires in grid 1.
h_{1y} is the height of wires in grid 1 that pass through the area element routed in the y direction.
w_{1y} is the width of wires in grid 1 that pass through the area element routed in the y direction.
R₁ₛ is the sheet resistance of wires in grid 1 routed in the y direction that pass through the area element.
L₁ⱼ is the mutual inductance per unit length between a wire in grid 1 routed in the y direction and the j^{th} wire in the grid.
J_{jy} is the component of average current density in the y direction in the j^{th} neighbouring wire.
w_{jy} is the width of the j^{th} neighbouring wire (routed in the y direction of an orthogonal grid described in a Cartesian coordinate system).
hⱼ is the height of the j^{th} neighbouring wire (routed in the y direction of an orthogonal grid described in a Cartesian coordinate system).

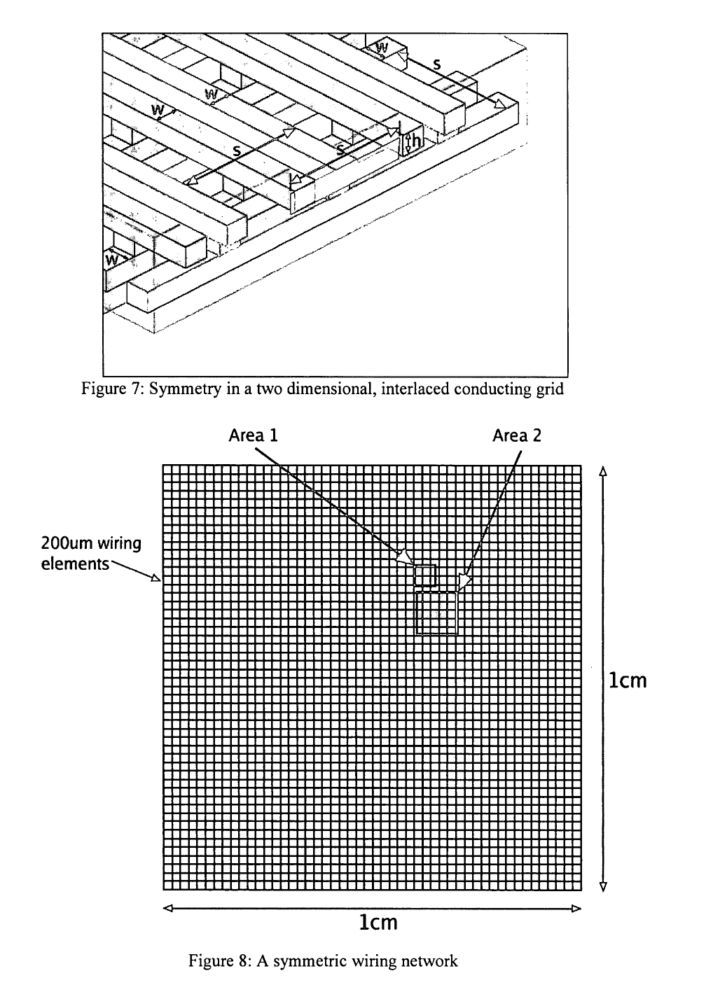

Equations 5.8, 5.10 and 5.11 include the detailed effects of electromagnetic coupling between many conductors and other components in the system. However, as indicated in section 4, the identification of symmetry in a network can be used to simplify the model. In this example the conducting grid has translational symmetry of period s in both x an y directions and the width w and height h of all conductors is the same for all wires in grids 1 and 2 (FIG. 7). If we select the area used to calculate the effective current density to have length equal to the wire pair periodic distance s and width equal to the wire height h, this symmetry can be used to simplify equations 5.8, 5.10 and 5.11.

If we further assume that neighbouring wires in grids 1 and 2 have currents of equal magnitude in opposite directions (i.e. The current flowing into an area in grid 1 is equal to the current flowing out of the same area in grid 2) then equation 5.8 reduces to:

$$- h ∇ \cdot \underline{{J}_{eff}} = {I}_{A} + {I}_{E} + {C}_{A} \frac{\partial V}{\partial t} \qquad ( 5.12 )$$

where:

V=V₁−V₂ (5.13)

is the potential difference between grids 1 and 2. Thus geometric and current symmetry results in a continuum model where only differential voltages and currents need to be calculated during simulations. This symmetry also results in a simplification of equations 5.10 an 5.11. Equal and opposite currents in closely coupled conducting pairs are known to confine most of the magnetic flux in the space between the two wires (i.e. The only significant mutual inductance is between close neighbours). This means that equation 5.10 reduces to:

$$- {dV}_{x} = {J}_{x} hw ( {R}_{s} \frac{dx}{w} ) + L dx \frac{\partial }{\partial t} ( {J}_{x} w h ) \qquad ( 5.14 )$$

where:
dVₓ is the (symmetric/differential) voltage change in the grid across an area element in the x direction.
Jₓ is the component of average wire current density in grids 1 and 2 through the area element in the x direction (equal in magnitude and opposite in sign in each of the interlaced grids).
Rₛ is the combined (sum of) sheet resistance of grid 1 and grid 2 wires within the area element.

Note that this is twice the sheet resistance of single wires in the symmetric grid (the grid voltage change includes the voltage drop/bounce in grid 1 and the voltage bounce/drop in grid 2).

L is the inductance per unit length calculated from the magnetic flux between and around neighbouring wires in grids 1 and 2 that pass through the area element.

Similarly, equation 11 reduces to:

$$- {dV}_{y} = {J}_{y} h w ( {R}_{s} \frac{dy}{w} ) + L dy \frac{\partial }{\partial t} ( {J}_{y} w h ) \qquad ( 5.15 )$$

where:
dV_{y} is the (symmetric) voltage change in the grid across an area element in the y direction.
J_{y} is the component of average wire current density in grids 1 and 2 through the area element in the y direction (equal in magnitude and opposite in sign in each of the interlaced grids).

As mentioned previously, the length and width of the rectangle used to calculate effective current density in the grid was chosen to match the grid geometry. Using equation 2.2 the x component of average current density is given by:

$${J}_{x} = \frac{s}{w} {J}_{xeff} \qquad ( 5.16 )$$

where J_{xeff} is the x component of the effective current density. The y component of average current density is given by:

$${J}_{y} = \frac{s}{w} {J}_{yeff} \qquad ( 5.17 )$$

where J_{yeff} is the y component of the effective current density. Combining equations 5.14 and 5.16 gives:

$$- \frac{{dC}_{x}}{\partial x} = ( \frac{h s {R}_{s}}{w} ) {J}_{xeff} + hs L \frac{\partial {J}_{xeff}}{\partial t} \qquad ( 5.18 )$$

Combining equations 5.15 and 5.17 gives:

$$- \frac{{dV}_{y}}{\partial y} = ( \frac{h s {R}_{s}}{w} ) {J}_{yeff} + hs L \frac{\partial {J}_{yeff}}{\partial t} \qquad ( 5.19 )$$

Equations 5.18 and 5.19 can be combined into the vector equation:

$$- ∇ V = ( \frac{hs {R}_{s}}{w} ) \underline{{J}_{eff}} + hs L \frac{\partial \underline{{J}_{eff}}}{\partial t} \qquad ( 5.20 )$$

which relates the potential gradient to the effective current density in a symmetric grid.

So far we have used the definition of effective current density (equation 2.1) and a careful symmetry based selection of effective area to derive two equations that relate differential voltage changes to the effective current density in a conducting network. Equations 5.12 and 5.20 can be used to simulate current and voltage changes at all points across the surface of a two dimensional grid. In general, the various parameters in these equations, such as resistance, inductance and capacitance are functions of position, time, current and voltage. If we suppose that the only parameter that gives rise to non-linearity in this equation is the area capacitance C_{A}, then, differentiating equation 5.12 with respect to t gives:

$$- h \frac{\partial }{\partial t} ( ∇ \cdot \underline{{J}_{eff}} ) = \frac{\partial {I}_{A}}{\partial t} + \frac{\partial {I}_{E}}{\partial t} + \frac{\partial }{\partial t} ( {C}_{A} \frac{\partial V}{\partial t} ) \qquad ( 5.21 )$$

Taking the divergence of equation 5.20 gives:

$$- {∇}^{2} V = ( \frac{hs {R}_{s}}{w} ) ∇ \cdot \underline{{J}_{eff}} + hs L \frac{\partial }{\partial t} ( ∇ \cdot \underline{{J}_{eff}} ) \qquad ( 5.22 )$$

Combining equations 5.12, 5.21 and 5.22 gives:

$$- \frac{w}{{sR}_{s}} {∇}^{2} V = {I}_{A} + {I}_{E} + \frac{\partial }{\partial t} ( {C}_{A} \frac{\partial V}{\partial t} ) + \frac{w L}{{R}_{s}} \frac{\partial }{\partial t} [ {I}_{A} + {I}_{E} + \frac{\partial }{\partial t} ( {C}_{A} \frac{\partial V}{\partial t} ) ] \qquad ( 5.23 )$$

This model can be used to simulate differential voltage changes in a symmetric, interlaced grid. It can be solved using standard numerical techniques such as the finite difference method or finite element methods. It is a continuum model where the entire conducting network, including insulators and other components, is represented by a single composite material. There is no need to divide the network into large numbers of wiring elements in this type of model. The size and number of wire elements in the grid determines the width (w), periodic space (s) and other parameters in equation 5.23.

The voltage and current changes in the symmetric conducting grid illustrated in FIG. 8 can be simulated using deconstruction techniques as described in the prior art. The grid consists of 2500 wiring elements. Each of the wiring elements consists of a transmission line pair connected at crossover points to create the type of network illustrated in more detail in FIG. 5. This type of grid can also be simulated using equation 5.23. In the continuum model the wiring elements are not considered separately. They are considered to be part of a composite structure as represented by the model. The physical characteristics of the grid depend on grid parameters such as wire width, periodic space, inductance per unit length etc.

A typical application of the grid shown in FIG. 8 is the global power distribution network in an integrated circuit. The large number of components connected to the grid can be used to derive the capacitance and currents per unit area for use in the model. The simulation results that follow were obtained using the following grid and connected device parameters:
Grid wire width w=5 um.
Grid wire periodic spacing s=200 um.
Grid wire sheet resistance Rₛ=50 mOhms.
Grid wire transmission line pair inductance per unit length L=10 nH/cm.
Grid capacitance per unit area outside area 2 C_{A}=10 nF/cm².
Grid capacitance per unit area within area 2 C_{A}=800 nF/cm².
Current per unit area outside area 1 I_{A}=0A/cm².

A 50 ps current pulse was used for the current per unit area within area 1. This pulse started at 0A/cm² at t=0 ps, rising to 80A/cm² at t=25 ps and falling back to 0A/cm² at t=50 ps. Ideal voltage sources were used at the grid boundary. The grid was assumed not to be connected to an external system. Thus the connectivity current I_{E} was set to 0A/cm² everywhere.

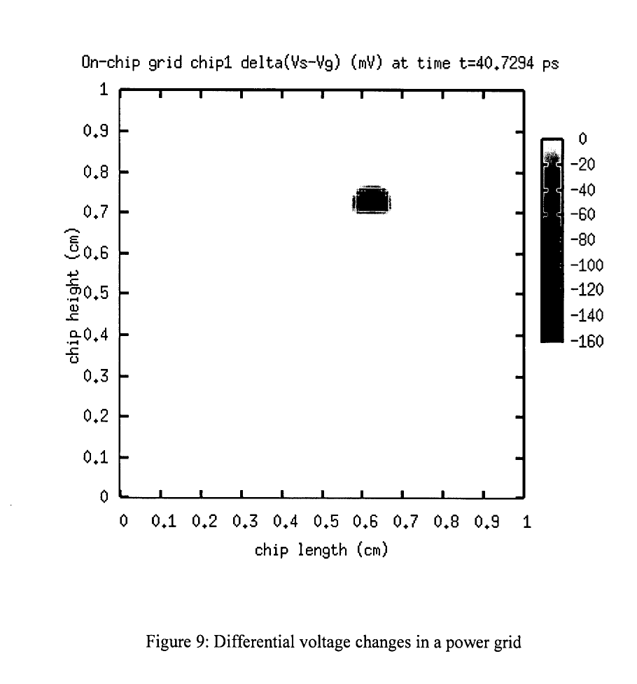

Equation 5.23 was solved using a finite difference method. A result from the simulation at a particular time (t˜40 ps) is shown in FIG. 9. The pulse applied to area 1 represents rapid changes in current that occur when large numbers of logic gates are switched within a region of the integrated circuit.

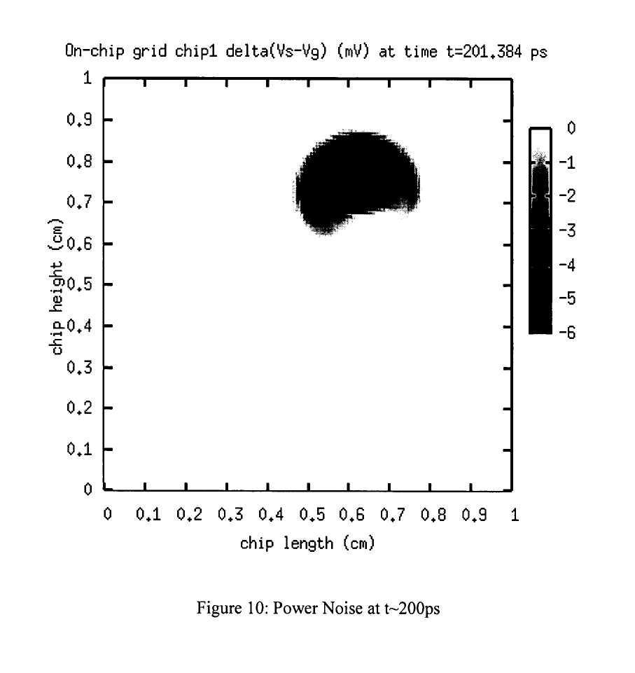

These rapid switching currents create noise in the power grid. These noise spikes propagate out from the source at a velocity that depends on the inductance and capacitance in the grid. FIG. 10 shows a result after the simulation is allowed to continue to t˜200 ps. The simulation shows clearly the noise suppression effect of the additional capacitance within area 2. The noise level, the rate at which it decays and the distance it propagates across the grid also depend on other parameters such as the wire sheet resistance and inductance.

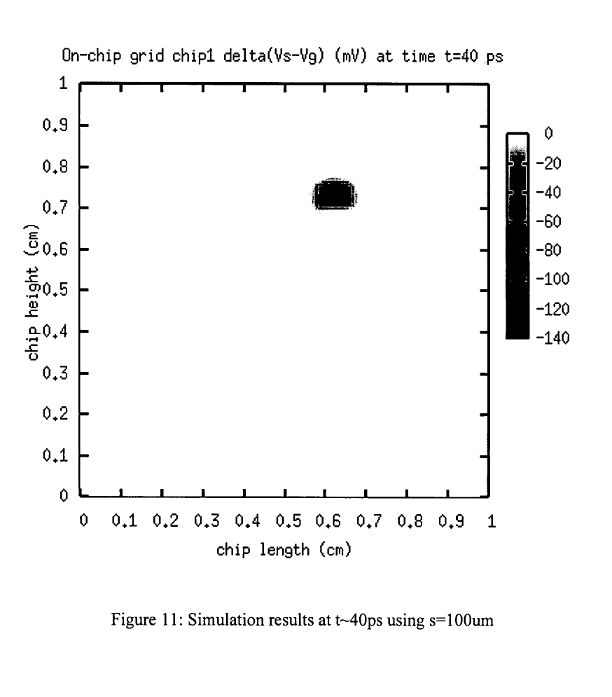

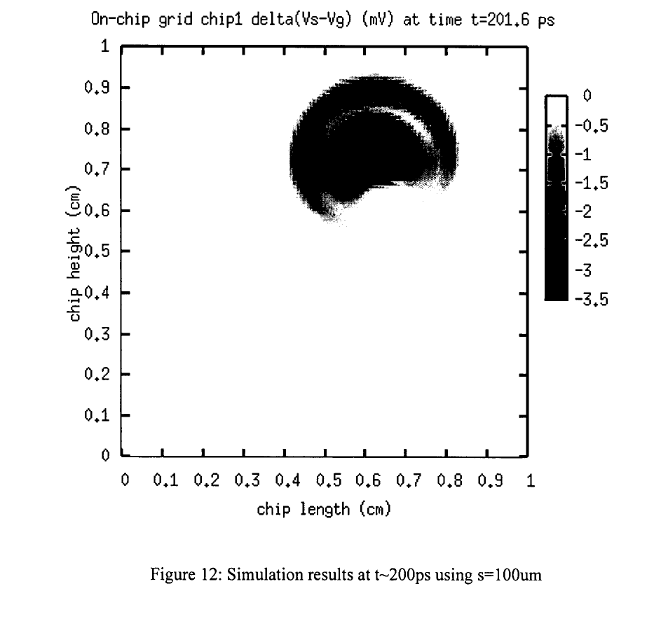

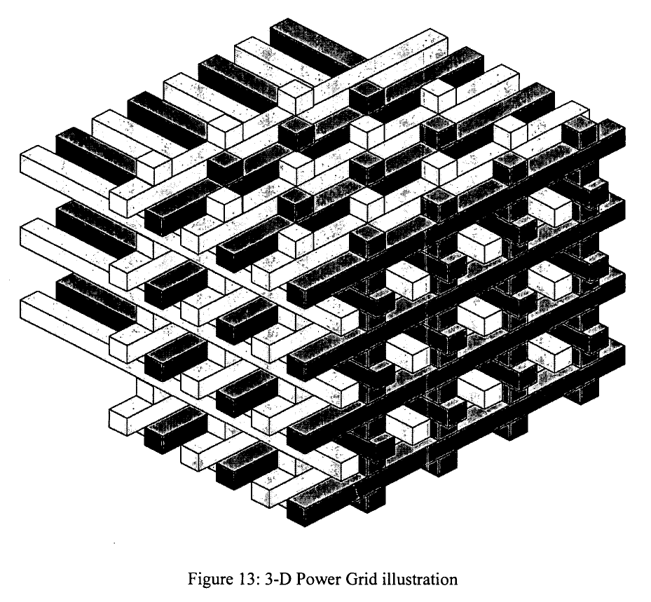

The following simulation results illustrate one of the main advantages of the effective current density method when compared with deconstruction techniques as used in the prior art. In SPICE and SPICE like derivatives the physical properties of each wiring element will first be extracted from the physical layout. In the above example each of the 2500 transmission line pairs could be represented by a resistor, capacitor, inductor combination giving 7500 components in the simulation netlist. Suppose it now becomes necessary to simulate a grid where the transmission line periodic space is reduced from 200 um to 100 um. The number of transmission line pairs in the grid rises to 10000 and the number of components to be simulated increases to 30000. This can have a dramatic effect on the simulation time and the computing resources required to run the simulation. Using the continuum model derived using the effective current density method there is no increase in simulation time or requirement for increased computing resource. A single parameter, the periodic distance s, is changed from 200 um to 100 um before re-starting the simulation. The result at t˜40 ps is shown in FIG. 11 and the result at t˜200 ps is shown in FIG. 12. The results show a modest noise reduction when additional wire elements are added to the grid. In this way a large number of simulations can be run to optimize the various grid and circuit components to minimize noise in the power distribution system.

The simulation results shown in FIGS. 9 to 12 show no indication of the actual conducting grid in the output. Models derived using effective current density are true continuum models in the sense that physical parameters such as voltage and current are calculated everywhere in the space occupied by the network. Parameters within a conducting wire or component can always be derived from the simulation results using the geometry of the network or the definition of the effective current density. For example, the voltage across a particular wire element can be obtained by identifying its position within the network and extracting the corresponding voltage at this position within the continuum model. The physical quantity called voltage does, in fact, exist everywhere within a network, including the space occupied by insulators between conducting wires. Real currents in a wire can always be obtained from the effective current density using equation 2.1.

One skilled in the art will appreciate that the methods of the invention, while described with reference to a pseudo-2-dimensional conducting network in the specification, are also just as effectively applicable to 3-dimensional conducting networks and conducting or semiconducting material. Practical applications of the methods of the invention in 3-D networks will be apparent and shown to be very useful as semiconductor fabrication technology progresses to the point where multiple layers of semiconductor material and metalization are stacked with short, interconnecting elements of a few tens of microns in length to form 3-dimensional power grid networks in 3-D chips.

Although specific method embodiments are illustrated and described herein, any procedure configured to achieve the same purposes and advantages may be substituted in place of specific embodiments disclosed. This disclosure is intended to cover and include any and all adaptations or variations of embodiments of the invention provided herein. All the descriptions provided in the specification have been made in an illustrative sense and should in no manner be interpreted in any restrictive sense. The scope, of various embodiments of the invention whether described or not, includes any other applications in which the structures, concepts and methods of the invention may be applied. The scope of the various embodiments of the invention should therefore be determined with reference to the appended claims, along with the full range of equivalents to which such claims are entitled. Similarly, the abstract of this disclosure, provided in compliance with 37 CFR §1.72(b), is submitted with the understanding that it will not be interpreted to be limiting the scope or meaning of the claims made herein. While various concepts and methods of the invention are grouped together into a single ‘best-mode’ implementation in the detailed description, it should be appreciated that inventive subject matter lies in less than all features of any disclosed embodiment, and as the claims incorporated herein indicate, each claim is to viewed as standing on its own as a preferred embodiment of the invention.

What is claimed is:

1. A method for current density representation, comprising:
the ratio of the total current flowing in a conductor to an arbitrary area that lies in a plane normal to the current flow;
where the arbitrary area does not coincide with the cross-sectional area of the conductor.

2. The method of claim 1, applied to any combination of insulators, semiconductors and conductors distributed in 1-, 2- or 3 dimensions such as transmission lines, 2-D conducting grids and 3-D conducting volumes.

3. The method of claim 1, applied to symmetric conducting structures of 1-, 2- or 3-dimensions comprising of any combination of insulators, semiconductors and conductors.

4. The method of claim 1, applied to asymmetric physical structures comprising of any combination of insulators, semiconductors and conducting material.

5. The method of claim 1, applied to the determination of electric charge and electromotive force variation in physical structures comprising of any combination of insulators, semiconductors and conducting material.

6. The method of claim 1, applied to voltage and current variation determination in on-chip power grid structures comprising of conducting material embedded in non-conducting insulators.

7. The method of claim 1, applied to voltage and current variation determination in integrated circuit package power grid structures comprising of conducting material embedded in non-conducting insulators.

8. The method of claim 1, applied to voltage and current variation determination in printed-circuit board power grid structures.

9. The method of claim 1, applied to voltage and current variation determination in patterned or electronic bandgap structures.

10. The method of claim 1, applied to voltage and current variation determination in physical structures comprised of conductors and insulators applied to electromagnetic radiation generation and reception.

11. A method for reducing computational complexity, comprising:
use of effective current density calculated as the ratio of the total current flowing normal to an arbitrary cross-sectional area to the cross sectional area;
combined with the assumption of symmetric positive and negative current flows in complementary conductors and correspondingly symmetric positive and negative voltage development in complementary conductors.

12. The method of claim 11, applied to determining voltage noise in on-chip, integrated circuit package or printed circuit board power grid structures.

13. The method of claim 11, incorporated into computer software or hardware employed to numerically determine charge, voltage and current variation in power grid structures.

14. The method of claim 11, incorporated into computer software or hardware employed to numerically determine charge, voltage and current variation in antenna structures.

15. The method of claim 11, incorporated into computer software or hardware employed to numerically determine charge, voltage and current variation in patterned or electronic bandgap structures.

16. A method, for reducing electrical simulation model complexity in conducting network structures, comprising:
representation of current density as the ratio of the total current flowing in a conductor to an arbitrary area that lies in a plane normal to the current flow, where the arbitrary area does not coincide with the cross-sectional area of the conductor;
and the reduction of a grid of interconnected conductor models with inductive, resistive and capacitive behaviour to a single simulation model represented by a single equation through the application of this current density representation.

17. The method of claim 16, incorporated into computer software or hardware employed to determine charge, voltage and current variation in power grid structures.

18. The method of claim 16, where translational or rotational symmetry is employed in reducing model complexity.

19. The method of claim 16, incorporated into computer software or hardware employed to determine charge, voltage and current variation in any combination of insulators, semiconductors and conducting structures.
